(19) United States
(12) Patent Application Publication
(10) Pub. No.: US 2011/0174112 A1
(43) Pub. Date: Jul. 21, 2011

(54) Method for the recovery of nobel metals

(76) Inventors: Viktor Andreevich Sinegribov, Flotskaya (RU); Andrei Filippovich Smetannikov, Koroleva (RU)

(21) Appl. No.: 12/998,179

(22) PCT Filed: Sep. 8, 2009
(86) PCT No.: PCT/RU2009/000454

§ 371 Date: Mar. 24, 2011

(30) Foreign Application Priority Data
Sep. 29, 2008 (RU) 2008138812

(51) Int. Cl. C22B 11/02

(52) U.S. Cl. 75/631

(57) ABSTRACT

The invention relates to methods of precious metals recovery and may be applied to the recovery of precious metals from mineral raw materials containing chlorides of alkali and earth metals, e.g. slimes of potassium production. The method includes the following: excessive chlorides and water are separated from the slimes containing precious metals and chlorides of alkali and earth metals, after which the slimes are forwarded to drying and roasting at the temperature of 850-950° C., and then the cider is leached by diluted solution of hydrochloric acid. The precious metals are recovered from the produced pulp by sorption with the help of resin (e.g. AM-2B).

### CROSS-REFERENCE TO RELATED APPLICATIONS

This application is a U.S. national phase application of a PCT application PCT/RU2009/000454 filed on 8 Sep. 2009, published as WO2010/036142, whose disclosure is incorporated herein in its entirety by reference, which PCT application claims priority of a Russian Federation patent application RU2008/138812 filed on 29 Sep. 2008.

### FIELD OF THE INVENTION

The invention relates to methods of precious metal recovery and may be applied to the recovery of precious metals (platinum, palladium, gold, etc.) from various types of mineral raw source materials containing chlorides of alkali and earth metals, e.g. slimes of potassium production.

There is known a method of potassium production slimes processing (Russian Federation Patent RU2132398, published on Jun. 27, 1999).

According to the aforementioned method, gold-containing slimes are cleaned of salts with the help of water, after which the salted water, formed during the cleaning, is removed, then fresh water is added to the slimes, and then the produced pulp is chlorinated by chlorine gas while care is taken to ensure that active chlorine content in leaching solution is maintained within 0.3-2.0 gram/L. After the leaching process is completed, gold is recovered by sorption.

A disadvantage of the aforementioned method is the need to thoroughly clean the chlorides and use elemental chlorine, a high toxic substance.

From the technical viewpoint, the closest to this invention is a method of precision metals recovery from mineral raw materials (Russian Federation Patent RU2291907, published on January, 2006). According to this method, the mineral raw materials are cleaned of excess chlorides with the help of water until the chlorides content is within 7-13%, after which the cleaned pulp undergoes concentration and then the concentrated product is dried and roasted at the temperature of 600-700° C. The precious metals are leached from the cinder using diluted solution of aqua-regia and then recovered from produced pulp by sorption.

A disadvantage of this method is an incomplete recovery of precious metals from slimes due to the loss of palladium with washing solutions during the washing-off of excessive chlorides of alkali and earth metals by water because of solubility of palladium chloride.

The aforesaid disadvantage is eliminated by means of using the proposed method.

The technological result achieved according to the proposed method consists in increasing the complex recovery of precious metals from processed materials as the result of avoiding the water washing-off of chlorides of alkali and earth metals and at the expense of fusion of compounds containing precious metals with chlorides of alkali metals resulting in formation of iron, aluminum, and silicon compounds soluble in water, and thereby recovering a part of precious metals which forms the finest fraction of the aforesaid materials.

To achieve the aforesaid technological result in the inventive method of precious metals recovery from mineral raw materials (containing precious metals and chlorides of alkali metals), comprises the steps of: -roasting; -enrichment and leaching of the cider and precious metals sorption; wherein the collective concentrate is produced during enrichment of the clay-salt residues (slimes of potassium production plants with the chlorides content of 15-30%) is used as the mineral raw material. This material is then granulated, after which the granules are roasted at a temperature of 500-950° C., and then precious metals are leached from the cider by the hydrochloric acid solution and recovered by sorption.

The distinctive features which make the proposed method different from the method earlier described as “the closest”, are the following: the collective concentrate produced during enrichment of clay-salt residues (slimes of potassium production enterprises with the chlorides content of 15-30%) is used as the mineral raw material; this material is then granulated, after which the granules are roasted at a temperature of 500-950° C. and then precious metals are leached from the cider by the hydrochloric acid and recovered by sorption.

Thanks to availability of these distinctive features, the inventive method provides for the complex recovery of precious metals.

The method is carried out in the following way.

Collective concentrate is produced during the enrichment of clay-salt residues (slimes of the plants processing potassium ores and rock-salt) which is a concentrated pulp with a solid-to-liquid (S:L) ratio=1:1. Insoluble residue is extracted from the collective concentrate without subsequent washing off chlorides, and then granulated. The produced granules are dried and roasted at a temperature of 500-950° C., making sintering of the slime minerals with the chlorides of alkali metals, after which the precious metals are leached from the cider by a hydrochloric acid solution and recovered from the produced pulp by sorption, e.g. with the help of AM-2B resin.

### EXAMPLE 1

Experiments were performed with the roasting of granulated insoluble residue with a chlorine content of 13.5-13.8% at a temperature of 500-900° C., leaching the ciders by a 3.8-normal solution of aqua-regia with a ratio (S:L) of 1:4 at a temperature of 65-70° C. for 4 hours, sorption of the precious metals using the AM-2B anionite, desorption of precious metals from the resin, and analysis of the content of precious metals.

As it's seen from experimental date placed in Table 1 below, the recovery of palladium increases practically uniformly from 1.78 to 4.82 gram/ton of the salt-less (demineralized) slimes, in the temperature range of 500-900° C.

TABLE 1
Recovery of precious metals from insoluble residue with
the chlorine content of 13.5-13.8%:

| | Recovered, g/t | | | |
|---|---|---|---|---|
| T_{roasting}, | from saltless insoluble residue | | | |
| ° C. | Pd | Pt | Au | Ag |
| 500 | 1.78 | <0.015 | 0.26 | 4.98 |
| 600 | 2.65 | 0.010 | 0.20 | 4.80 |
| 700 | 3.74 | 0.095 | 0.54 | 3.60 |
| 800 | 3.03 | <0.017 | 0.24 | 45.4 |
| 900 | 4.82 | 0.156 | 0.18 | 24.1 |

### EXAMPLE 2

Experiments were performed with the roasting of granulated insoluble residue, for the same batch as in Example 1, with the chlorine content of 18.4% at the temperature of 500-900° C., and with the ciders processing at the same conditions as in Example 1 (see Table 2 below).

TABLE 2
Recovery of precious metals from insoluble residue with
the chlorine content of 18.4%:

| | Recovered, g/t | | | |
|---|---|---|---|---|
| T_{roasting}, | from saltless insoluble residue | | | |
| ° C. | Pd | Pt | Au | Ag |
| 500 | 1.74 | <0.015 | 0.076 | 0.76 |
| 600 | 3.24 | 0.024 | 0.127 | 0.98 |
| 700 | 4.67 | 0.112 | 0.616 | 7.33 |
| 800 | 3.79 | 0.062 | 0.150 | 1.95 |
| 900 | 11.8 | 0.264 | 3.20 | 3.42 |

As seen from the data of Table 2, like in the previous example, the recovery of palladium increases practically uniformly in the temperature range of 700-800° C.; however then it increases sharply, achieving 11.8 gram/ton of the salt-less (demineralized) slimes at the temperature of 900° C.

Simultaneously, the recovery of platinum and gold increases sharply.

It should be noted that an excessive ratio of the washing-off of insoluble residue is followed by a decrease of the palladium and platinum content in the obtained product.

### EXAMPLE 3

TABLE 3
Leaching of ciders by mixture HCl + HNO₃
Lump size of the cider: 2 mm
Leaching parameters: ratio (S:L) = 1:4
Temperature: 90° C.
Time: 4 hours

| | Recovered, g/t | | | |
|---|---|---|---|---|
| Cl content, | from insoluble residue | | | |
| % | Pd | Pt | Au | Ag |
| 11.8 | 1.71 | 0.17 | 0.06 | 0.72 |
| 14.1 | 1.8 | 0.23 | 0.04 | 0.73 |
| 15.1 | 2.3 | 0.13 | 0.29 | 11.3 |
| 15.4 | 4.66 | 0.73 | 0.10 | 1.62 |
| 16.2 | 4.89 | 0.76 | 0.27 | 3.84 |

A batch of insoluble residue was divided into 5 parts, which were washed off to remove chlorides up to various ratios. Then insoluble residue was separated from the excessive solution and then granulated. The produced granules (in the form of 20 kg batches) were roasted at a temperature of 850° C., and the ciders were processed at the same conditions as in Example 1 (see Table 3 above).

Therefore, Table 3 shows that an excessive washing of insoluble residue is followed by a considerable decrease of the palladium content in the obtained product and therefore by a decrease of its recovery.

### EXAMPLE 4

The samples of granulated insoluble residue prepared in the same way as in the Examples 1-2, were roasted at a temperature of 850° C. and the ciders were divided into two parts. The half of the ciders were processed at the same conditions as in the Example 1, parallel samples were leached by 10% solution of hydrochloric acid while the rest parameters were kept unchanged.

TABLE 4
Comparative data on leaching metals by acids
Temperature of roasting: 850° C.
Lump size of granule: 8 mm

| | | Recovered, g/t | | | |
|---|---|---|---|---|---|
| | | from saltless insoluble residue | | | |
| Sample | Acid | Pd | Pt | Au | Ag |
| 1 | HCl | 3.57 | <0.014 | 0.030 | 0.63 |
| | HCl + HNO₃ | 0.90 | 0.250 | 0.021 | 0.48 |
| 2 | HCl | 9.63 | 0.370 | 1.86 | 2.76 |
| | HCl + HNO₃ | 7.56 | <0.015 | 0.05 | 0.59 |
| 3 | HCl | 1.59 | 0.018 | 0.210 | 0.07 |
| | HCl + HNO₃ | 1.13 | 0.890 | 0.086 | 1.00 |
| 4 | HCl | 2.15 | <0.017 | 0.084 | 0.08 |
| | HCl + HNO₃ | 1.26 | 0.690 | 0.164 | 0.55 |
| 5 | HCl | 2.44 | <0.016 | 0.220 | 0.08 |
| | HCl + HNO₃ | 1.05 | <0.015 | 0.071 | 1.39 |

As seen from the data of Table 4 above, in all cases of using hydrochloric acid the recovery of palladium is considerably higher. A trivalent iron, transferring to the solution during the cider leaching, serves as the oxidizer which is necessary for dissolution of metallic palladium and platinum being formed at a temperature over 600° C. as the result of decomposition of these metals' chlorides (see Table 5 below).

TABLE 5
Iron and aluminum recovery to the solution

| | Recovered, g/t | |
|---|---|---|
| T_{roasting}, | from saltless insoluble residue | |
| ° C. | Fe | Al |
| 500 | 7.70 | 3.22 |
| 600 | 8.56 | 4.06 |
| 700 | 7.39 | 5.02 |
| 800 | 9.59 | 8.54 |
| 900 | 8.95 | 9.24 |

The technological effectiveness of the proposed method of precious metal recovery from mineral raw materials containing chlorides of alkali and earth metals, is derived from the fact that during its application the maximal and complex recovery of the platinum group metals, gold and silver from the aforesaid mineral raw materials is possible. The technological sequence of processing the mineral raw materials is simplified and the water consumption is decreased due to avoiding operations of the excessive washing of chlorides. Technological conditions of the cider processing are simplified as well, and environment protection is improved due to avoiding the application of nitric acid.

1. Method of precious metals recovery from mineral raw materials containing chlorides of alkali and earth metals; the method includes roasting, leaching of cider, with the following distinctive feature: the collective concentrate produced during enrichment of clay-salt residues (slimes of potassium production enterprises with the chlorides content of 15-30%) is used as the mineral raw material; this material is then granulated, after which the granules are roasted at the temperature of 500-950° C. and then precious metals are leached from the cider by hydrochloric acid and recovered by sorption.
